(19) United States
(12) Patent Application Publication
(10) Pub. No.: US 2023/0287931 A1
(43) Pub. Date: Sep. 14, 2023

(54) BEARING ARRANGEMENT

(71) Applicant: Vibracoustic SE, Darmstadt (DE)

(72) Inventors: Hilrich Kardoes, Winsen (DE); Ralf Steinhardt, Schwerin (DE); David Rose, Hamburg (DE); Philipp Werner, Lüneburg (DE)

(21) Appl. No.: 18/119,929

(22) Filed: Mar. 10, 2023

(30) Foreign Application Priority Data
Mar. 10, 2022 (DE) 10 2022 105 703.8

(51) Int. Cl. F16C 33/04; F16C 17/04

(52) U.S. Cl. CPC F16C 33/046; F16C 17/04

(57) ABSTRACT

A bearing arrangement includes a bearing receiver which has at least one receiver region. In embodiments a first resilient shaped body and a second resilient shaped body are inserted into the receiver region. The first and second resilient shaped bodies may be held so as to be pretensioned by a pretensioning device. In embodiments the at least one receiver region includes a first receiver and a second receiver, a base is configured with a through-hole between the first and the second receiver, and/or the base may form an axial limit for the first shaped body and for the second shaped body.

### CROSS-REFERENCE TO RELATED APPLICATION

This application claims priority to German Patent Application No. DE 10 2022 105 703.8, filed Mar. 10, 2022, the contents of which are hereby incorporated by reference in its entirety.

### TECHNICAL FIELD

The invention relates to a bearing arrangement, including a bearing arrangement comprising axially pretensioned bearings.

### BACKGROUND

Bearing arrangements, in particular bearing arrangements comprising axially pretensioned bearings, are generally known. The bearing arrangements are used, for example, for bearing systems for E-motors or as battery bearing systems. Generally, the bearing arrangements have a bearing receiver with a receiver opening into which one or more elastomer shaped bodies are inserted as bearings. An elastomer shaped body is understood to mean a shaped body made of an elastomer material. For example, it is known that two such bearings are introduced from two opposing sides into a bearing receiver. The bearings can be fixed by a material connection by means of bonding agents (bonded bearings) or even simply held positively or non-positively in the receiver (unbonded bearings). Irrespective of the fixing, the bearings can be screwed-in such that they are subjected to compressive pretensioning in the axial direction.

For example, DE 31 38 534 A1 discloses two externally unbonded cone bearings. The two bearings are supported and fixed on the outer peripheral side by means of sleeves. The inner faces of the bearings are fixed to tubular portions, either similarly unbonded or by a material connection by means of bonding agents.

Unbonded cone bearings, which create compressive stress when subjected to compression in the axial direction, generally provide the advantage that they permit a high level of progression but at the same time are not subjected to tension. In the case of long compression paths, however, there is the risk that the compressed bearings slip in an uncontrolled manner into the bearing receiver. In particular, there is the risk that the bearing jams in the bearing receiver and in the worst case does not rebound fully back into the initial position. In the case of double cone bearings in which two bearings oppose one another in the axial direction in the bearing receiver, there is the additional risk that the bearing slipping into the bearing receiver pushes the opposing rebounding bearing out of its seat, whereby this bearing can be brought into an uncontrolled position.

Proceeding therefrom, therefore, it can be desirable to provide a bearing arrangement, such as an unbonded axial bearing, which can address or remedy the aforementioned challenges or drawbacks. For example, it may be desirable to provide an improved bearing arrangement in which the bearing is reliably prevented from jamming. Additionally, in the case of opposing bearings, the opposing bearings may be desirably designed to be prevented from being able to push one another out of a bearing receiver. It may also be desirable that externally unbonded bearings are not able to fall out of the bearing receiver. It can also be desirable to provide a bearing arrangement that is able to be produced, for example, by simple means and cost-effectively.

### SUMMARY

Various features and embodiments of the invention are disclosed herein.

A bearing arrangement, comprising a bearing receiver which has at least one receiver region, wherein a first resilient shaped body and a second resilient shaped body are inserted into the receiver region, wherein the resilient shaped bodies are held so as to be pretensioned by a pretensioning device, is characterized in that the receiver region has a first receiver and a second receiver, wherein a base is configured with a through-hole between the first and the second receiver and wherein the base forms an axial limit for the first resilient shaped body and for the second resilient shaped body.

A bearing arrangement is an arrangement which may include a bearing receiver and at least one bearing inserted therein. The bearing may be a translational bearing which permits a spring mounting in an axial direction. A bearing receiver is a component which may be suitable (and configured) to receive a bearing. The bearing receiver may include a receiver region. In the assembled state, the bearing may be inserted into the receiver region. The receiver region may, for example, comprise a recess that is configured in the bearing receiver. The recess can also be configured or denoted as a hollow shape configured in the bearing receiver. The shape of the recess may correspond to an external shape of the bearing. In embodiments, this may be advantageous, so that the bearing can be inserted in a uniform manner into the recess.

The receiver region and the bearing have in each case a central longitudinal axis. In the assembled state, the central longitudinal axis of the receiver region may correspond to the central longitudinal axis of the bearing. The bearing receiver may be rotationally symmetrical but at least substantially axially symmetrical relative to its own longitudinal axis. The same applies to the bearing. The spring movement of the bearing takes place substantially along this longitudinal axis.

Both the first and the second resilient shaped body are bearings. Together they form a double bearing. The bearing arrangement in this regard is an arrangement which consists of a bearing receiver and a double bearing inserted therein.

The pretensioning device may hold the two bearings so as to be pretensioned against one another. To this end, the pretensioning device may exert pressure from both sides in the axial direction on the shaped bodies inserted into the bearing receiver.

The base may be arranged in the center of the receiver region, when viewed along a longitudinal axis. The base may have the shape of a disk-shaped circular ring. The first receiver and the second receiver may be separated from one another by the base. The first receiver and the second receiver may be substantially of the same size. In embodiments, the first receiver and the second receiver are configured mirror-symmetrically to one another, wherein the base forms the mirror axis. The first shaped body is inserted into the first receiver. The second shaped body is inserted into the second receiver. The shaped bodies are thus arranged opposite one another in the receiver region and thus in the bearing receiver. It can be seen in this regard that the bearing arrangement is an unbonded axial bearing.

The base may form an axial limit for the first and the second shaped bodies. The axial limit may define the mobility in an axial direction. In other words, the base may define the path which the shaped bodies can cover in the axial direction in the bearing receiver. It is not necessary for the shaped bodies to be in contact with the base in the KO position. In this regard, the base can also serve as a stop for the shaped bodies in the axial direction. It is also conceivable that the shaped body is in direct contact with the base. It can be advantageous here if the contact surface between the shaped body and the base is as large as possible. The contact surface between the shaped body and the base is also denoted as the footprint, irrespective of whether the shaped body and the base are actually in contact with one another or only come into contact with one another when the bearing is subjected to load.

It can be seen, amongst other things, that by means of the base it is possible to prevent one of the shaped bodies from being able to push the other shaped body out of the bearing receiver. In other words, the one bearing cannot be pushed out by the other bearing when subjected to axial load. It is also possible to prevent one of the shaped bodies from slipping further down into the bearing receiver than is desired. In this regard, the risk of the bearings jamming or wedging in the bearing receiver is significantly reduced by means of the base and this applies, in particular, when the bearing receiver is shaped such that it has a narrow point in the center. At the same time, no adhesion is necessary in order to hold the shaped bodies in the correct position, and yet relatively long spring paths can be possible.

In an embodiment, it is provided that the shaped bodies in each case have a receiver for a bearing core which extends through the shaped bodies in the axial direction. This receiver for a bearing core is denoted hereinafter in short as a bearing core receiver. The bearing core receiver can have a diameter which is uniform over its entire length. It may be preferred, however, if the bearing core receiver has a first portion in which it has a first diameter and a second portion in which it has at least one second diameter. The first diameter can be a uniform diameter, the clear width thereof in terms of shape and size corresponding to the external periphery of the bearing core. For example, the bearing core receiver can have a cylindrical shape in the region of its first portion. In the second portion, the diameter of the bearing core receiver is preferably greater than the external diameter of the bearing core. The bearing core receiver can have a conical shape in the region of its second portion. In the assembled state, preferably in the axial direction, the first portion of the bearing core receiver is arranged remote from the base of the bearing receiver. The second portion is preferably arranged toward the base. The second diameter is preferably larger than the external diameter of the bearing core. In the region of the second portion, therefore, a free space is configured between the elastomer shaped body and the bearing core. In some embodiments, it may be preferred if the second diameter is not uniform in the axial direction. For example, the second diameter can become uniformly larger toward the base at least in a part of the second portion or even beyond the entire second portion. It is conceivable, for example, that the bearing core receiver in the second portion initially has a conical shape which ultimately leads into a cylindrical shape. The conical part is designed such that when the shaped body is inserted into the bearing receiver, the diameter thereof increases toward the base of the bearing receiver. It is particularly advantageous if the diameter of the cylindrical part is not smaller than the largest diameter of the conical part.

In an embodiment, it is provided that the receivers at least partially form a radial cylindrical limit portion for the respective shaped body in the radial direction. The respective receiver has an inner face. At least in the region of the radial cylindrical limit portion, in the assembled state the shaped body bears with its outer face against the inner face of the receiver. In the region of the radial cylindrical limit portion, the shaped body bears against the inner face such that the inner face of the receiver forms an abutment for the shaped body. In this manner, longer movement paths of the bearing can be implemented, since with the same contact area of the shaped body on the base, the free space in the region of the second portion of the bearing core receiver can be increased between the elastomer shaped body and the bearing core inserted into the shaped body.

In a further exemplary embodiment, it is provided that at least one of the receivers is shaped to be entirely or partially conical. In this regard the receiver has at least one conical portion, hereinafter denoted as the conical receiver portion. The conical receiver portion is preferably designed such that the diameter thereof increases outwardly in the axial direction, i.e. in the direction which extends away from the base of the bearing receiver. If the receiver is shaped to be only partially conical, it may be preferred if the conical receiver portion of the receiver is configured in the axial direction on the side of the receiver remote from the base of the bearing receiver. A conical configuration of the receiver can facilitate, for example, the insertion of the shaped body into the receiver. It is also conceivable, for example, that at least one of the receivers is shaped to be entirely or partially cylindrical. Thus it is conceivable, for example, that the receiver has a cylindrical portion, hereinafter denoted as the cylindrical receiver portion. The cylindrical receiver portion can be, for example, the radial cylindrical limit portion already described above. It is also conceivable, however, that the entire receiver is configured to be cylindrical. It is also conceivable that the receiver has both a conical and a cylindrical receiver portion. For example, when viewed in the axial direction from the base, the receiver can initially have a cylindrical receiver portion and then a conical receiver portion which becomes increasingly large.

It is also advantageous if at least one receiver has an undercut. An undercut narrows the receiver in a small region. In other words, the undercut narrows the receiver at least in some portions. A receiver comprising an undercut can have, for example, a first and a second receiver portion. The first cylindrical receiver portion is the receiver portion located in the vicinity of the base and the second cylindrical receiver portion is the receiver portion located remote from the base. The undercut is thus configured directly at the transition between the first receiver portion and the second receiver portion. In other words, the undercut is configured at the point where the first receiver region and the second receiver region adjoin one another. For example, the diameter of the first receiver portion is larger than the diameter of the second receiver portion. An offset is produced by the difference in the size of diameter. This offset forms the undercut. It is also conceivable that the undercut is a projection which protrudes into the receiver.

A resilient shaped body inserted into the corresponding receiver can thus positively engage in the first receiver portion and at the undercut encounter a stop or a limit to its freedom of movement in the axial direction away from the base. In principle, both receiver portions can have the same or different shapes. It is also conceivable that the two receiver portions are cylindrical receiver portions. However, it is also conceivable that one of the two receiver portions has a conical shape or even that the two receiver portions are shaped to be at least partially conical.

In a variant, it is conceivable that a fixing ring is pressed into the receiver region in at least one of the receivers. The fixing ring can form the above-described undercut. At the same time, the fixing ring narrows the diameter of the receiver in some portions, namely at the point at which it is inserted into the receiver. By means of a pressed-in fixing ring the bearing receiver itself can be designed without an undercut in the axial direction. The bearing receiver is thus able to be produced cost-effectively by means of a casting method without post-machining. It is also conceivable that at least one bore hole which is oriented in the radial direction is configured as a latching recess in the bearing receiver. An undercut can also be configured by means of such a latching recess. The receiver in the region of the latching recesses also has a larger radial extent outwardly than in the adjoining receiver portion in the axial direction. In this regard, an offset and thus an undercut are also produced at the transition between the latching recess and the adjoining receiver portion. A further advantage of such a bore hole is that lateral holes can be configured during the production of the bearing receiver by means of slides in the casting mold, for example when using a pressure casting mold. Thus it is possible to form undercuts which do not have to be manufactured by machining.

In a variant, it is conceivable that at least one of the shaped bodies has a support collar. The support collar can be supported on the front face of the bearing receiver. In this regard, the support collar can provide an additional hold for the shaped body in the axial direction. The support collar can be configured at the end of the shaped body, which in the assembled state is arranged remote from the base.

In a further variant, it is conceivable that at least one of the shaped bodies has an elastomer latching ring. The latching ring can be configured at the end of the shaped body such that in the assembled state it is located in the vicinity of the base. The latching ring increases the external periphery of the shaped body at least in some portions. In the assembled state, the latching ring can also positively engage behind the undercut. To this end the latching ring can have, for example, a bearing surface which in the assembled state bears against the undercut.

It is also conceivable that at least one of the shaped bodies has one or more elastomer latching cams. The latching cams at least partially increase the external diameter of the shaped body. The latching cams can engage in latching recesses which are configured in the bearing receiver. The shaped body can thus be fixed in the bearing receiver by means of the latching cams. The latching cams and the latching recess form a resilient positive connection. The latching recess can be, for example, an above-described bore hole. It is also conceivable that in the assembled state the latching cam bears against a fixing ring or an undercut, as described above, which is formed by a narrowing of the diameter between the first receiver portion and the second receiver portion.

In a further variant, it is conceivable that at least one of the shaped bodies has an elastomer latching groove. In the assembled state this latching groove, for example, can encompass or receive the undercut. This is the case, in particular, when the undercut is formed, for example, by an inserted fixing ring or protrudes as a projection into the receiver. In this regard, the groove is a peripheral recess in the shaped body.

Further features, details and advantages of the invention are found in the wording of the claims and in the following description of the exemplary embodiments with reference to the drawings. In the drawings:

### BRIEF DESCRIPTION OF THE DRAWINGS

FIG. 1 shows a cross section along the central axis through a first embodiment of the bearing arrangement,

FIG. 2 shows a cross section along the central axis through a further embodiment of the bearing arrangement,

FIG. 3 shows a cross section along the central axis through a further embodiment of the bearing arrangement,

FIG. 4 shows a cross section along the central axis through a further embodiment of the bearing arrangement,

FIG. 5 shows a cross section along the central axis through a further embodiment of the bearing arrangement,

FIG. 6 shows a cross section along the central axis through a further embodiment of the bearing arrangement.

### DETAILED DESCRIPTION

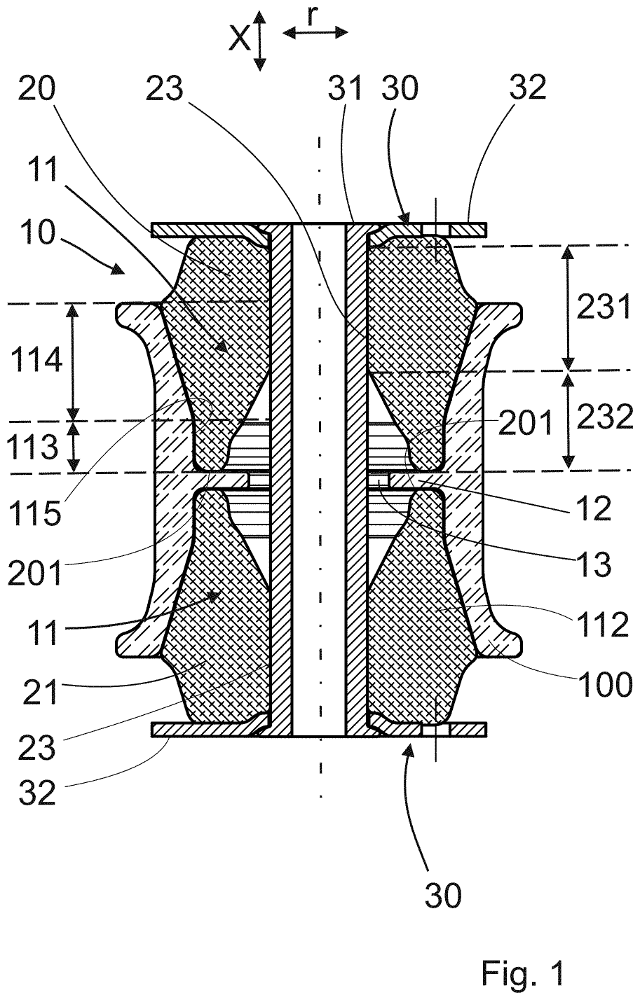

FIG. 1 shows an embodiment of a bearing arrangement 10. The bearing arrangement 10 has a bearing receiver 100 with a receiver region 11. The receiver region 11 has two receivers 111, 112, namely a first receiver 111 and a second receiver 112. A base 12 is formed between the first receiver 111 and the second receiver 112. A through-hole 13 is configured in the base 12. A shaped body 20, 21 is inserted into each of the receivers 111, 112. In this regard, the bearing arrangement 10 has a first shaped body 20 and a second shaped body 21. The first shaped body 20 and the second shaped body 21 are arranged opposite one another in the receiver region 11. Each of the two shaped bodies 20, 21 has a bottom surface 201 on the front face. It can be seen that the base 12 for each of the shaped bodies 20, 21 forms an axial limit. In FIG. 1 the bottom surface 201 of the shaped bodies 20, 21 bears against the base 12.

The shaped bodies 20, 21 have in each case a recess 23. The bearing core 31 is received in this recess 23. The recess 23 has a first portion 231 and a second portion 232. The internal diameter of the first portion 231 corresponds in terms of shape and size to the external diameter of the bearing core 31. The internal diameter of the second portion 232 is larger than the external diameter of the bearing core 31. Moreover, the first portion 231 is substantially cylindrical. The second portion 232 is conical at least in some portions.

The bearing core 31 extends through both shaped bodies 20, 21 and is fixed in the example shown in FIG. 1 by two end plates 32. In this manner, pressure can be exerted on the shaped bodies in the axial direction, so that the shaped bodies 20, 21 are held so as to be pretensioned in the receiver region 11.

In the exemplary embodiment shown in FIG. 1, the first and second receiver 111, 112 in each case have a first region 113, which directly adjoins the base 12, and a second region 114 which is arranged in the axial direction remote from the base 12. The first region 113 is configured to be cylindrical. The second region 114 is configured to be conical. At least the inner wall 115 of the cylindrically configured first region 113, in each case serves as a radial limit for the shaped bodies 20, 21. In this regard, the shaped bodies 20, 21 inserted into the receivers 111, 112 of the receiver region 11 encounter an axial or radial limit both on the base 12 and on the inner wall 115 of the respective receiver 111, 112. It can be seen that the first region 113 forms a radial cylindrical limit portion for the shaped body 20, 21.

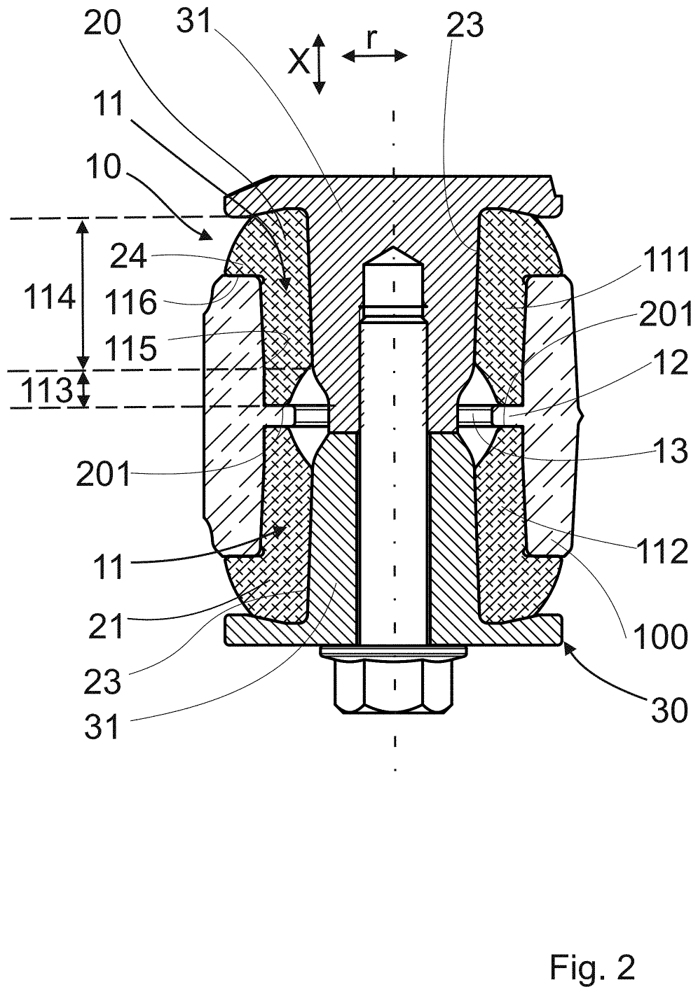

The variants of the bearing arrangement 10 shown in FIGS. 2, 3, 4, 5 and 6 also have in each case a bearing receiver 100 comprising a receiver region 11. The receiver region has in each case a first receiver 111 and a second receiver 112, wherein a base 12 is configured with a through-hole 13 between the first receiver 111 and the second receiver 112. A shaped body 20, 21 is also inserted in each of the receivers 111, 112, wherein each of the two shaped bodies 20, 21 has a bottom surface 201 on the front face. The base 12 forms an axial limit for each of the shaped bodies 20, 21.

The shaped bodies 20, 21 in each case have a recess 23. The bearing core 31 is received in this recess 23. The recess 23 has a first portion 231 and a second portion 232. The internal diameter of the first portion 231 corresponds in terms of shape and size to the external diameter of the bearing core 31. The internal diameter of the second portion 232 is larger than the external diameter of the bearing core 31. Moreover, the first portion 231 is substantially cylindrical. The second portion 232 is conical at least in some portions. The inner wall 115 of the receivers 111, 112 serves in each case at least in some portions as a radial limit for the shaped bodies 20, 21. In this regard, the shaped bodies 20, 21 inserted into the receivers 111, 112 of the receiver region 11 encounter an axial or radial limit both on the base 12 and on the inner wall 115 of the respective receiver 111, 112.

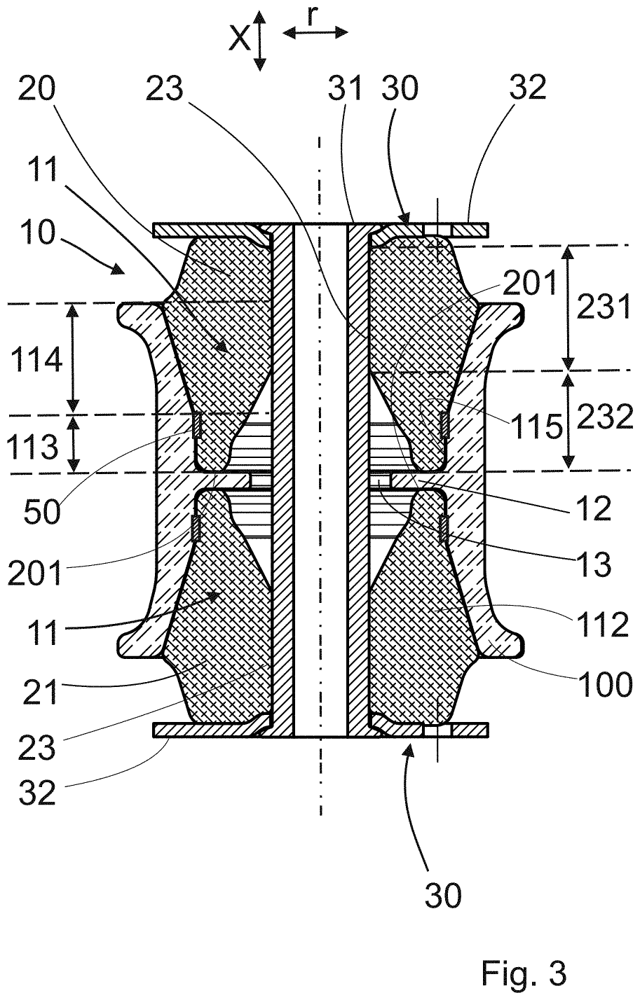

In the exemplary embodiment shown in FIGS. 3, 4 and 5, the receivers 111, 112 also have, as in the exemplary embodiment shown in FIG. 1, in each case a first region 113 which directly adjoins the base 12 and a second region 114 which is arranged remote from the base 12 in the axial direction. The first region 113 is configured to be cylindrical. The second region 114 is configured to be conical. At least the inner wall 115 of the cylindrically configured first region 113, serves in each case as a radial limit for the shaped bodies 20, 21. In this regard, the shaped bodies 20, 21 inserted into the receivers 111, 112 of the receiver region 11 encounter an axial or radial limit both on the base 12 and on the inner wall 115 of the respective receiver 111, 112. In all four examples (FIGS. 1, 3, 4 and 5) the internal diameter of the first region 113 is at least predominantly smaller than the internal diameter of the second region 114. The internal diameter of the conical part of the second region 114 becomes larger in the axial direction x facing away from the base.

In the exemplary embodiment shown in FIG. 2, the receivers 111, 112 are configured to be cylindrical in each case and consist of a single continuous region. Here the inner face 115 also forms a radial limit for the shaped bodies 20, 21.

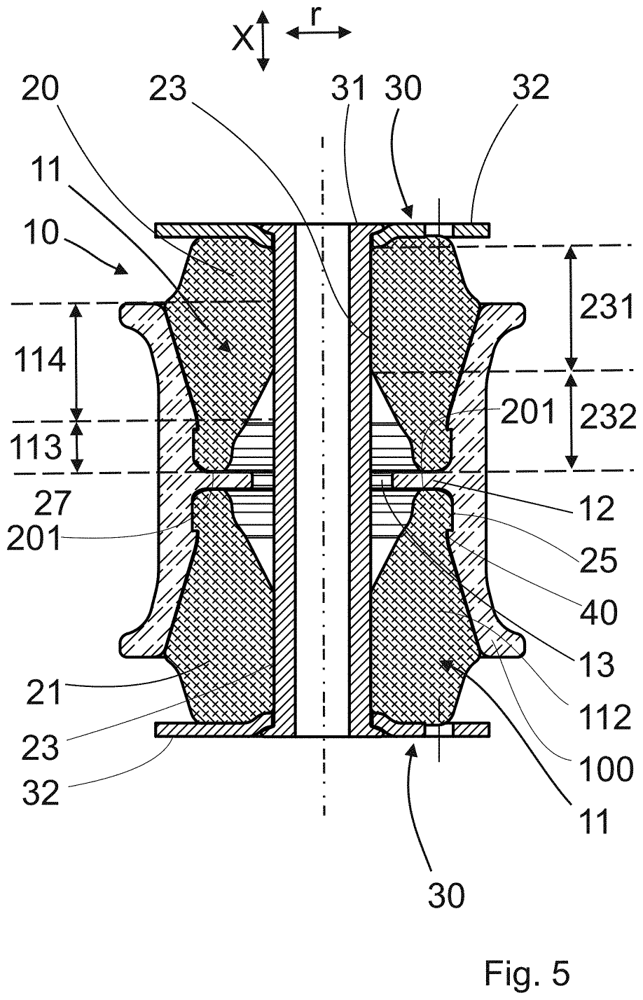

In the exemplary embodiment shown in FIG. 5, the diameter of the second region 114 in a small region, namely at the point at which the first region 113 and the second region 114 adjoin one another, is smaller than the diameter of the first region 113. In this manner, an undercut 40 is formed. In the remaining part of the region 114, however, the diameter of the region 114 is larger than the diameter of the region 113, so that here the internal diameter of the first region is at least predominantly smaller that the internal diameter of the second region 114. The shaped bodies 20, 21 in each case have a latching ring 25. The latching ring 25 engages behind the undercut 40. In this manner, the undercut 40 and the latching ring 24 limit the movement of the respective shaped body 20, 21 in the axial direction x.

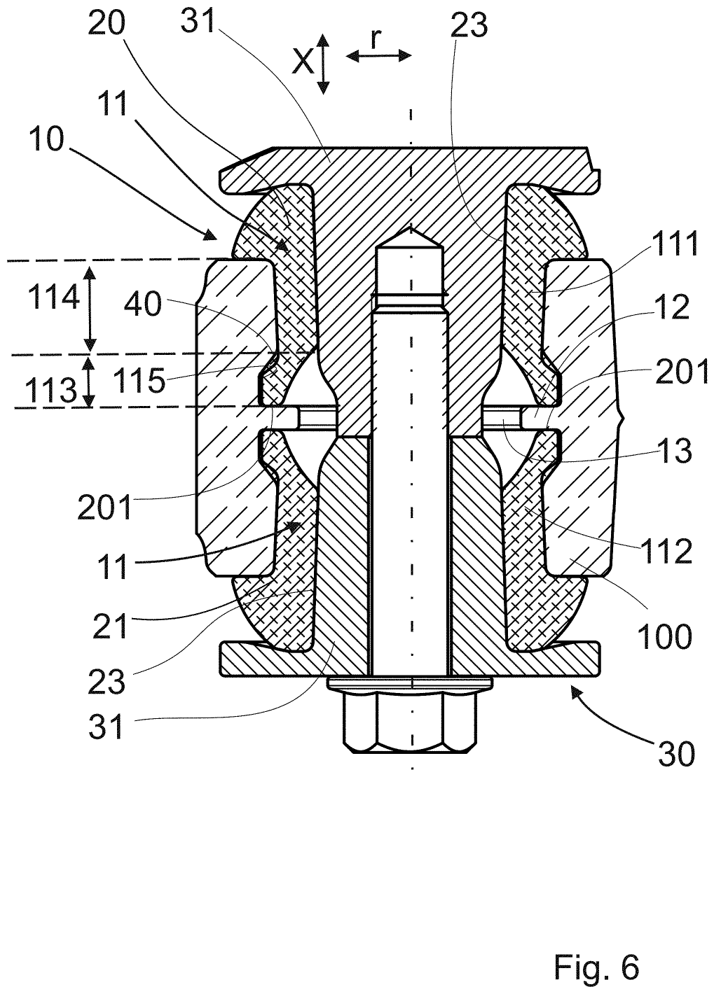

In the exemplary embodiment shown in FIG. 6, the receivers 111, 112 have, as in the examples in FIGS. 1, 3, 4 and 5, in each case a first region 113 and a second region 114. The first region 113, which is configured as described above in the vicinity of the base 12, has a first cylindrical part and a conical portion which follows in the axial direction x and which adjoins the second region 114. The second region 114 is configured to be cylindrical. In this exemplary embodiment, the internal diameter of the second region 114 is smaller than the internal diameter of the first region 113. In this manner, an undercut 40 is configured between the first region 113 and the second region 114. Here the shaped bodies 20, 21 have in each case a latching ring 25 which together with the undercut 40 limits a movement of the respective shaped body 20, 21 in the axial direction x.

In the exemplary embodiments shown in FIG. 2 and FIG. 6, the bearing receiver 100 also has in each case a front face 116 at both ends. The shaped bodies have in each case a support collar 24 with a support surface 241. The support surface 241 bears against the front face 116 of the bearing receiver 100. In this regard, the support collar 24 provides additional protection against the respective shaped body 20, 21 slipping further than intended into the receiver 111, 112.

In the exemplary embodiment shown in FIG. 3, it can be seen that a fixing ring 50 is inserted in each case into the receivers 111, 112. The fixing ring 50 is arranged at the transition between the first region 113 and the second region 114. The shaped bodies 20, 21 have in each case a latching groove 27. The latching groove 27 positively encompasses the fixing ring 50. The fixing ring 50 acts as a narrowing of the receiver 111, 112 and thus as the above-described undercut 40.

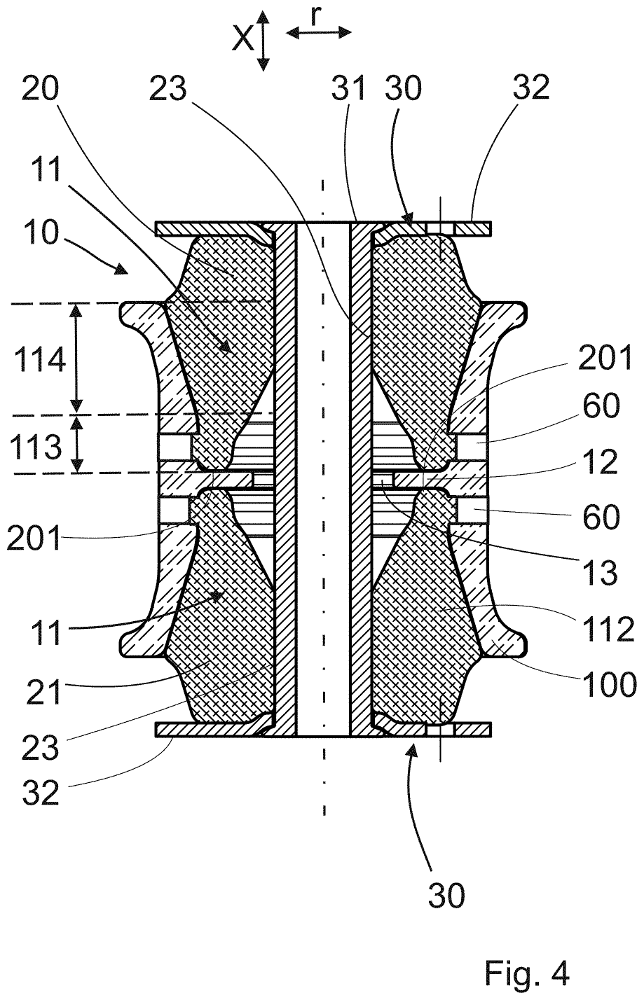

In the exemplary embodiment shown FIG. 4, radial bore holes 60 are configured in each case in the first region 113 of the receivers 111, 112, i.e. bore holes 60 which are oriented in the radial direction r. In the region of the bore holes 60, the diameter of the first region 113 is larger than the diameter of the adjoining part of the second region 114. In this regard, the bore holes 60 also act as an undercut 40. The shaped bodies 20, 21 have latching cams 26. The latching cams 26 engage in the bore holes 60 in the assembled state.

The invention is not limited to one of the above-described embodiments but can be modified in many different ways.

It is conceivable, for example, that the receivers 111, 112 are symmetrically configured. However, it is also possible that the receivers 111, 112 are combinations of the different variants shown above. Thus it is conceivable that a first receiver 111 has an undercut 40, while a fixing ring 50 is inserted into the second receiver or a corresponding radial bore 60 is configured. All possible combinations of the above-described variants are conceivable.

In any case, in a bearing arrangement 10, but in particular in a bearing arrangement 10 comprising axially pretensioned cone bearings, comprising a bearing receiver 100 which has at least one receiver region 111, 112 for a shaped body 20, 21, a resilient shaped body 20, 21 is inserted into the receiver region 111, 112. The resilient shaped body 20, 21 is held so as to be pretensioned by means of a pretensioning device 30. The pretensioning device 30 has a bearing core 31. The bearing core 31 extends in the axial direction x through the shaped bodies 20, 21. The receiver region 11 has a base 12 with a through-hole 13. The base 12 is arranged between the first receiver 111 and the second receiver 112. The base 12 forms a limit for the shaped body 20, 21 in the axial direction x.

One or both of the receivers 111, 112 can have a first region 113 and a second region 114 in the axial direction x. The first region 113 is configured in the axial direction x on the side of the receiver 111, 112 facing the base, and the second region 114 is configured on the side remote from the base. At least one of the two regions 113, 114 can be configured to be cylindrical, while the other region is configured to be entirely or partially conical. It is also conceivable that both regions 113, 114 are configured to be cylindrical. In this regard, both the first region 113 and the second region 114 can form a radial cylindrical limit portion 41.

All of the features and advantages set forth in the claims, the description and the drawing, including structural details, spatial arrangements and method steps, can be essential to the invention both individually and also in very different combinations.

1. A bearing arrangement, comprising a bearing receiver having at least one receiver region, wherein a first resilient shaped body and a second resilient shaped body are inserted into the at least one receiver region, wherein the first resilient shaped body and the second resilient shaped body are held to be pretensioned by a pretensioning device, wherein the receiver region has a first receiver and a second receiver, wherein a base includes a through-hole between the first and the second receiver, and wherein the base forms an axial limit for the first resilient shaped body and for the second resilient shaped body.

2. The bearing arrangement of claim 1, wherein the first and second resilient shaped bodies each have a receiver for a bearing core which extends through the first and second resilient shaped bodies in an axial direction.

3. The bearing arrangement of claim 1, wherein the first and second receivers at least partially form a radial cylindrical limit portion for the first and second resilient shaped bodies in a radial direction.

4. The bearing arrangement of claim 1, wherein at least one of the first receiver and the second receiver is shaped to be entirely or partially conical.

5. The bearing arrangement of claim 1, wherein at least one of the first receiver and the second receiver is shaped to be entirely or partially cylindrical.

6. The bearing arrangement of claim 1, wherein at least one of the first receiver and the second receiver has an undercut.

7. The bearing arrangement of claim 1, wherein a fixing ring is pressed into the at least one receiver region in at least one of the first and second receivers.

8. The bearing arrangement of claim 1, wherein at least one of the first resilient shaped body and a second resilient shaped body includes a support collar.

9. The bearing arrangement of claim 1, wherein at least one bore hole which is oriented in a radial direction is configured as a latching recess in the bearing receiver.

10. The bearing arrangement of claim 1, wherein at least one of the first resilient shaped body and a second resilient shaped body includes an elastomer latching ring.

11. The bearing arrangement of claim 1, wherein at least one of the first resilient shaped body and a second resilient shaped body includes one or more elastomer latching cams.

12. The bearing arrangement of claim 1, wherein at least one of the first resilient shaped body and a second resilient shaped body includes an elastomer latching groove.
